(19) United States
(12) Patent Application Publication
(10) Pub. No.: US 2018/0143033 A1
(43) Pub. Date: May 24, 2018

(54) METHOD AND SYSTEM FOR LANE-BASED VEHICLE NAVIGATION

(71) Applicant: Faraday&Future Inc., Gardena, CA (US)

(72) Inventor: YongGe Hu, San Jose, CA (US)

(21) Appl. No.: 15/639,338

(22) Filed: Jun. 30, 2017

Related U.S. Application Data
(60) Provisional application No. 62/357,288, filed on Jun. 30, 2016.

(51) Int. Cl. G01C 21/36; G01C 21/34

(52) U.S. Cl. CPC G01C 21/3658; G01C 21/3484; G01C 21/3691; G01C 21/3602; G01C 21/3617

(57) ABSTRACT

A system for lane-based vehicle navigation is disclosed. The system may comprise one or more sensors configured to detect a number of occupants in a vehicle and a processing unit coupled to the one or more sensors to receive signals from the one or more sensors. The processing unit may be configured to determine a current position of the vehicle, determine a destination of the vehicle, determine a route from the current position to the destination, and determine a recommended lane of the route based on the detected number of occupants.

### CROSS-REFERENCE TO RELATED APPLICATIONS

This application claims the benefit of U.S. Provisional Application No. 62/357,288, filed Jun. 30, 2016, the entirety of which is hereby incorporated by reference.

### TECHNICAL FIELD

The present disclosure relates generally to methods and systems for vehicle navigation, and more particularly, to methods and systems for lane-based vehicle navigation.

### BACKGROUND

Roadways may comprise a number of designated lanes including, for example, a carpool lane, a high-occupancy vehicle (HOV) lane, a passing lane, an express lane, a bus lane, a truck lane, or an emergency lane. Such lanes may appear similarly, may be marked, or may be divided. Different lanes on the same roadway may or may not share the same exit ramp. For example, a 4-lane highway may have, from left to right, a carpool lane, a passing lane, an express lane, and a local lane; and at a certain township, the carpool lane has an exit ramp from the left side of the highway, while the other lanes share an exit ramp from the right side.

Current vehicle navigation technologies are not able to distinguish lanes on the same roadway, and therefore, cannot navigate vehicles correctly in certain situations. In the example of the above-described highway, existing vehicle navigation services would recommend the driver to exit the highway from the right side regardless of the current lane of the vehicle. In another example, existing vehicle navigation services would not be able to navigate vehicles through the least congested lane at a toll booth. In yet another example, if a particular lane is blocked by debris, crashed cars, or shoveled snow, existing vehicle navigation services would not be able to warn drivers or navigate them away from the blocked lane.

### SUMMARY

One aspect of the present disclosure is directed to a system for lane-based vehicle navigation. The system may comprise one or more sensors configured to detect a number of occupants in a vehicle and may comprise a processing unit coupled to the one or more sensors to receive signals from the one or more sensors. The processing unit may be configured to determine a current position of the vehicle, determine a destination of the vehicle, determine a route from the current position to the destination, and determine a recommended lane of the route based on the detected number of occupants.

Another aspect of the present disclosure is directed to a vehicle. The vehicle may comprise a system for lane-based vehicle navigation. The system may comprise one or more sensors configured to detect a number of occupants in a vehicle and may comprise a processing unit coupled to the one or more sensors to receive signals from the one or more sensors. The processing unit may determine a current position of the vehicle, determine a destination of the vehicle, determine a route from the current position to the destination, and determine a recommended lane of the route based on the determined number of occupants.

Another aspect of the present disclosure is directed to a method for lane-based vehicle navigation. The method may comprise determining a number of occupants in a vehicle, determining a current position of the vehicle, determining a destination of the vehicle, determining a route from the current position to the destination, and determining a recommended lane of the route based on the determined number of occupants.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a graphical representation illustrating a vehicle for lane-based vehicle navigation, consistent with exemplary embodiments of the present disclosure.

FIG. 2 is a block diagram illustrating a system for lane-based vehicle navigation, consistent with exemplary embodiments of the present disclosure.

FIG. 3 is a flowchart illustrating a method for lane-based vehicle navigation, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Current vehicle navigation technologies are not able to distinguish lanes on the same roadway, and therefore, cannot navigate vehicles correctly in certain situations, such as those described in the background section. The disclosed systems and methods may mitigate or overcome one or more of the problems set forth above and/or other problems in the prior art.

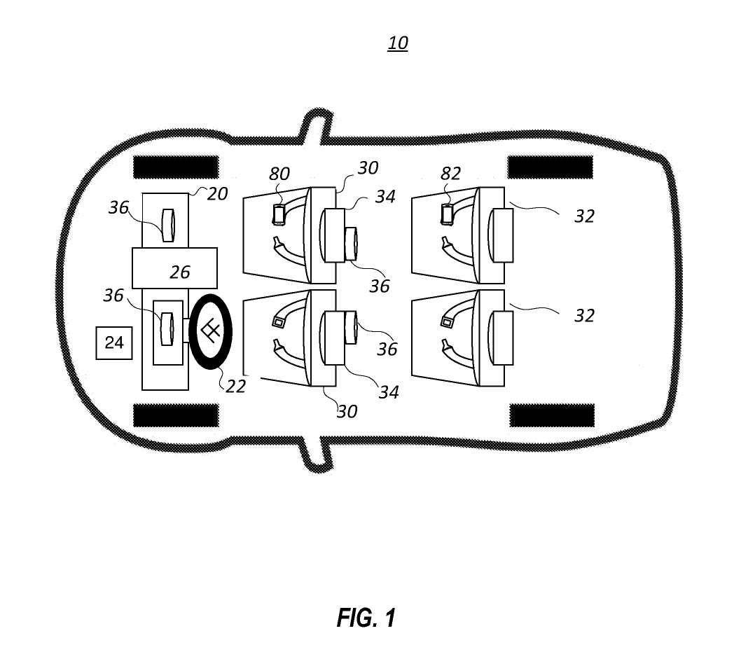

FIG. 1 is a graphical representation illustrating a vehicle 10 for lane-based vehicle navigation, consistent with exemplary embodiments of the present disclosure. Vehicle 10 may have any body style of an automobile, such as a sports car, a coupe, a sedan, a pick-up truck, a station wagon, a sports utility vehicle (SUV), a minivan, or a conversion van. Vehicle 10 may also embody other types of transportation, such as motorcycles, boats, buses, trains, and planes. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomous.

As illustrated in FIG. 1, vehicle 10 may include a number of components, some of which may be optional. Vehicle 10 may have a dashboard 20 through which a steering wheel 22 and a user interface 26 may project. In one example of an autonomous vehicle, vehicle 10 may not include steering wheel 22. Vehicle 10 may also have one or more front seats 30 and one or more back seats 32 configured to accommodate occupants. Vehicle 10 may further include one or more sensors 36 configured to detect and/or recognize occupants. The positions of the various components of vehicle 10 in FIG. 1 are merely illustrative. For example, sensor 36 may include an infrared sensor disposed on a door next to an occupant, and/or a weight sensor embedded in a seat. Vehicle 10 may also include detector and GPS unit 24 disposed at various locations, such as the front of the vehicle. The detector may include an onboard camera.

In some embodiments, user interface 26 may be configured to receive inputs from users or devices and transmit data. For example, user interface 26 may have a display including an LCD, an LED, a plasma display, or any other type of display, and provide a graphical user interface (GUI) presented on the display for user input and data display. User interface 26 may further include speakers or other voice playing devices. User interface 26 may further include input devices, such as a touchscreen, a keyboard, a mouse, and/or a tracker ball. User interface 26 may further include a housing having grooves containing the input devices. User interface 26 may be configured to provide internet access, cell phone access, and/or in-vehicle network access, such as Bluetooth™, CAN bus, or any other vehicle bus architecture protocol that may be used to access features or settings within vehicle 10. User interface 26 may be further configured to display or broadcast other media, such as maps and lane-specific route navigations.

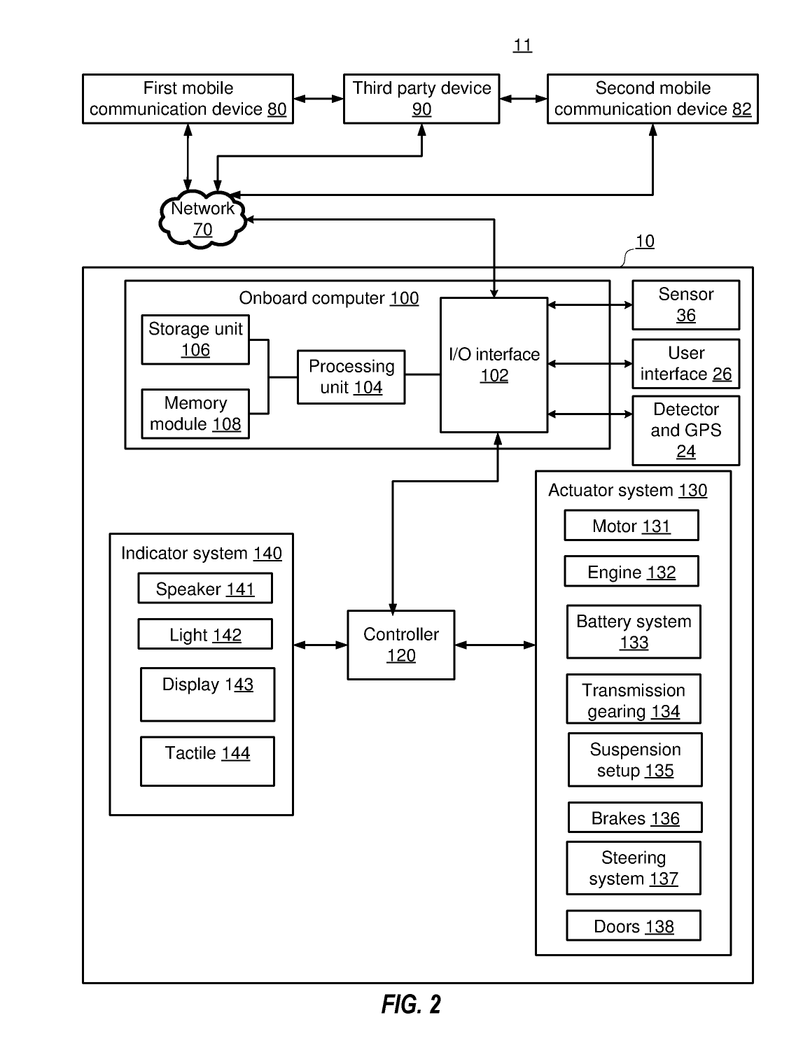

User interface 26 may also be configured to receive user-defined settings. For example, user interface 26 may be configured to receive occupant profiles including, for example, an age, a gender, a driving license status, an advanced driver assistance systems (ADAS) license status, an individual driving habit, a frequent destination, a store reward program membership, and etc. In some embodiments, user interface 26 may include a touch-sensitive surface configured to receive biometric data (e.g., detect a fingerprint of an occupant). The touch-sensitive surface may be configured to detect the ridges and furrows of a fingerprint based on a change in capacitance and generate a signal based on the detected fingerprint, which may be processed by an onboard computer described below with reference to FIG. 2. The onboard computer may be configured to compare the signal with stored data to determine whether the fingerprint matches recognized occupants. The onboard computer may also be able to connect to the Internet, obtain data from the Internet, and compare the signal with obtained data to identify the occupants. User interface 26 may be configured to include biometric data into a signal, such that the onboard computer may be configured to identify the person who is generating an input. Furthermore, user interface 26 may be configured to store data history accessed by the identified people.

Sensor 36 may include any device configured to generate a signal to be processed to detect and/or recognize occupants of vehicle 10, for example, camera, microphone sound detection sensor, infrared sensor, weight sensor, radar, ultrasonic, LIDAR, or wireless sensor for obtaining identification from occupants' cell phones. In one example, a camera 36 may be positioned on the back of a headrest 34 of a front seat 30 to capture images of an occupant in a back seat 32. In some embodiments, visually captured videos or images of the interior of vehicle 10 by camera 36 may be used in conjunction with an image recognition software, such that the software may distinguish a person from inanimate objects, and may recognize the person based on physical appearances or traits. The image recognition software may include a facial recognition software configured to match a captured occupant with stored profiles to identify the occupant. In some embodiments, more than one sensor may be used in conjunction to detect and/or recognize the occupant(s). For example, sensor 36 may include a camera and a microphone, and captured images and voices may both work as filters to identify the occupant(s) from the stored profiles.

In some embodiments, sensor 36 may include electrophysiological sensors for encephalography-based autonomous driving. For example, fixed sensor 36 may detect electrical activities of brains of the occupant(s) and convert the electrical activities to signals, such that the onboard computer can control the vehicle based on the signals. Sensor 36 may also be detachable and head-mountable, and may detect the electrical activities when worn by the occupant(s).

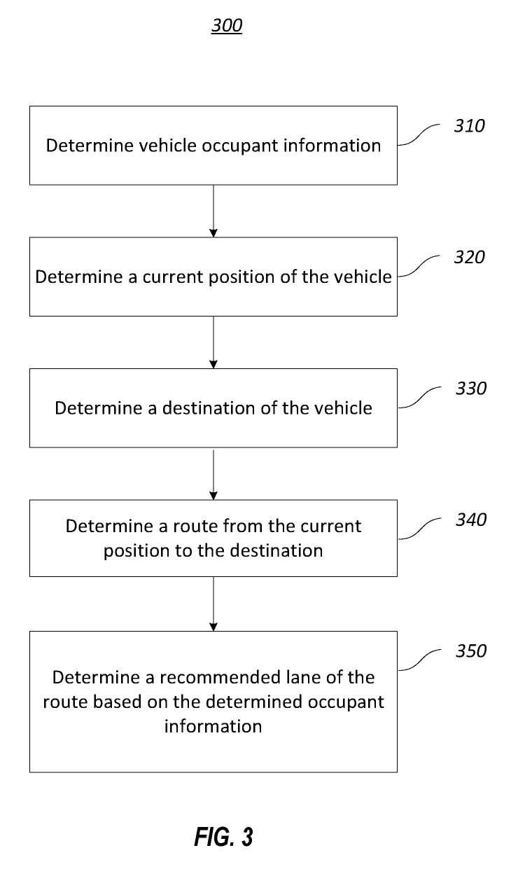

Detector and GPS 24 may determine in real time the location of vehicle 10 and/or information of the surrounding environment, such as street signs, lane patterns, road marks, road conditions, environment conditions, weather conditions, and traffic conditions, and send the information for processing as described below with reference to FIG. 2 and FIG. 3.

Vehicle 10 may be in communication with a plurality of mobile communication devices 80, 82. Mobile communication devices 80, 82 may include a number of different structures. For example, mobile communication devices 80, 82 may include a smart phone, a tablet, a personal computer, a wearable device, such as a smart watch or Google Glass™, and/or complimentary components. Mobile communication devices 80, 82 may be configured to connect to a network, such as a nationwide cellular network, a local wireless network (e.g., Bluetooth· or WiFi), and/or a wired network. Mobile communication devices 80, 82 may also be configured to access apps and websites of third parties, such as iTunes™, Pandora™, Google™, Facebook™, and Yelp™.

In some embodiments, mobile communication devices 80, 82 may be carried by or associated with one or more occupants in vehicle 10. For example, vehicle 10 may be configured to determine the presence of specific people based on a digital signature or other identification information from mobile communication devices 80, 82. For instance, an onboard computer may be configured to relate the digital signature to stored profile data including the person's name and the person's relationship with vehicle 10. The digital signature of mobile communication devices 80, 82 may include a determinative emitted radio frequency (RF) or a global positioning system (GPS) tag. Mobile communication devices 80, 82 may be configured to automatically connect to or be detected by vehicle 10 through local network 70, e.g., Bluetooth™ or WiFi, when positioned within a proximity (e.g., within vehicle 10).

FIG. 2 is a block diagram illustrating a system 11 for lane-based vehicle navigation, consistent with exemplary embodiments of the present disclosure. System 11 may include a number of components, some of which may be optional. As illustrated in FIG. 2, system 11 may include vehicle 10, as well as other external devices connected to vehicle 10 through network 70. The external devices may include mobile terminal devices 80, 82, and third party device 90. Vehicle 10 may include a specialized onboard computer 100, a controller 120, an actuator system 130, an indicator system 140, a sensor 36, a user interface 26, and a detector and GPS unit 24. Onboard computer 100, actuator system 130, and indicator system 140 may all connect to controller 120. Sensor 36, user interface 26, and detector and GPS unit 24 may all connect to onboard computer 100. Onboard computer 100 may comprise, among other things, an I/O interface 102, a processing unit 104, a storage unit 106, a memory module 108. The above units of system 11 may be configured to transfer data and send or receive instructions between or among each other. Storage unit 106 and memory module 108 may be non-transitory and computer-readable and store instructions that, when executed by processing unit 104, cause vehicle 10 to perform the methods described in this disclosure. The onboard computer 100 may be specialized to perform the methods and steps described below.

I/O interface 102 may also be configured for two-way communication between onboard computer 100 and various components of system 11, such as user interface 26, detector and GPS 24, and sensor 36, and the external devices. I/O interface 102 may send and receive operating signals to and from mobile communication devices 80, 82 and third party devices 90. I/O interface 102 may send and receive the data between each of the devices via communication cables, wireless networks, or other communication mediums. For example, mobile communication devices 80, 82 and third party devices 90 may be configured to send and receive signals to I/O interface 102 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Third party devices 90 may include smart phones, personal computers, laptops, pads, and/or servers of third parties (e.g., Google Maps™) that provide access to contents and/or stored data (e.g., maps, traffic, store locations, and weather). Third party devices 90 may be accessible to the users through mobile communication devices 80, 82 or directly accessible by onboard computer 100, via I/O interface 102, according to respective authorizations of the user. For example, users may allow onboard computer 100 to receive contents from third party devices by configuring settings of accounts with third party devices 90 or settings of mobile communication devices 80, 82.

Processing unit 104 may be configured to receive signals and process the signals to determine a plurality of conditions of the operation of vehicle 10, for example, through controller 120. Processing unit 104 may also be configured to generate and transmit command signals, via I/O interface 102, in order to actuate the devices in communication.

In some embodiments, processing unit 104 may be configured to determine the presence of people within an area, such as occupants of vehicle 10. Processing unit 104 may be configured to determine the identity of the occupants through a variety of mechanisms. For example, processing unit 104 may be configured to determine the presence of specific people based on a digital signature from mobile communication devices 80, 82. For instance, processing unit 104 may be configured to relate the digital signature to stored data including the person's name and the person's relationship with vehicle 10. The digital signature of communication device 80 may include a determinative emitted radio frequency (RF), GPS, Bluetooth™, or WiFi unique identifier. Processing unit 104 may also be configured to determine the presence of people within vehicle 10 by GPS tracking software of mobile communication devices 80, 82. In some embodiments, vehicle 10 may be configured to detect mobile communication devices 80, 82 when mobile communication devices 80, 82 connect to local network 70 (e.g., Bluetooth™ or WiFi).

In some embodiments, processing unit 104 may also be configured to recognize occupants of vehicle 10 by receiving inputs into user interface 26. For example, user interface 26 may be configured to receive direct inputs of the identities of the occupants. User interface 26 may also be configured to receive biometric data (e.g., fingerprints) from occupants when manipulating user interface 26. Processing unit 104 may be further configured to recognize occupants by facial recognition software used in conjunction with sensor 36.

In some embodiments, processing unit 104 may be configured to access and collect sets of data related to the people within the area in a number of different manners. Processing unit 104 may be configured to store the sets of data in a database. In some embodiments, processing unit 104 may be configured to access sets of data stored on mobile communication devices 80, 82, such as apps, audio files, text messages, notes, and messages. Processing unit 104 may also be configured to access accounts associated with third party devices 90, by either accessing the data through mobile communication devices 80, 82 or directly accessing the data from third party devices 90. Processing unit 104 may be configured to receive data directly from occupants, for example, through access of user interface 26. For example, occupants may be able to directly input vehicle settings, such as a desired internal temperature. Processing unit 104 may also be configured to receive data from history of previous inputs of the occupant into user interface 26.

In some embodiments, processing unit 104 may be configured to extract data from the collected sets of data to determine the occupant's interests and store the extracted data in a database. For example, processing unit 104 may be configured to determine favorite restaurants or types of food through occupant search histories or Yelp™ reviews. Processing unit 104 may be configured to store data related to an occupant's previous destinations using vehicle 10. Processing unit 104 may further be configured to execute character recognition software to determine the contents of messages or posts of occupants on social media to recognize keywords related to interests.

Storage unit 106 and/or memory module 108 may be configured to store one or more computer programs that may be executed by onboard computer 100 to perform functions of system 11. For example, storage unit 106 and/or memory module 108 may be configured to store biometric data detection and processing software configured to determine the identity of people based on fingerprint(s), and store image recognition software configured to relate images to identities of people. Storage unit 106 and/or memory module 108 may be further configured to store data and/or look-up tables used by the processing unit. For example, storage unit 106 and/or memory module 108 may be configured to include data related to individualized profiles of people related to vehicle 10. In some embodiments, storage unit 106 and/or memory module 108 may store the stored data and/or the database described in this disclosure.

Vehicle 10 can also include a controller 120 connected to the onboard computer 100 and capable of controlling one or more aspects of vehicle operation, such as performing autonomous parking or driving operations using instructions from the onboard computer 100.

In some examples, the controller 120 is connected to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. Steering system 137 may include steering wheel 22 described above with reference to FIG. 1. The onboard computer 100 can control, via controller 120, one or more of these actuator systems 130 during vehicle operation; for example, to open or close one or more of the doors of the vehicle using the door actuator system 138, to control the vehicle during autonomous driving or parking operations, using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle or part of user interface 26), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). Onboard computer 100 can control, via controller 120, one or more of these indicator systems 140 to provide indications to a driver of the vehicle of one or more characteristics of the vehicle's surroundings. The characteristics may be determined by sensor 36.

FIG. 3 is a flowchart illustrating a method 300 for lane-based vehicle navigation, consistent with exemplary embodiments of the present disclosure. Method 300 may include a number of steps, some of which may be optional. The steps may also be rearranged in another order. For example, steps 320 and 330 may be performed in either order or concurrently.

In Step 310, one or more components of system 11 may determine vehicle occupant information, such as a number of the occupants or identities of the occupants.

In some embodiments, vehicle 10 may detect a number of occupants in vehicle 10. For example, sensor 36 may include a cellphone detection sensor that detect the occupants according to mobile communication devices 80, 82 connected to a local wireless network (e.g., Bluetooth™) of vehicle 10, and transmit the detected number to processing unit 104. For another example, user interface 26 may detect the occupants according to manual entry of data into vehicle 10, e.g., occupants selecting individual names through user interface 26, and transmit the detected number to processing unit 104. Processing unit 104 may also collect biometric data (e.g., fingerprint data) from the occupants through user interface 26. For another example, sensor 36 may include cameras that capture images of occupants, microphones that capture voices of occupants, and/or weight sensors that capture weights of objects on the vehicle seats. Based on the received data from these sensors, processing unit 104 may determine a number of occupants in vehicle 10.

In some embodiments, one or components of system 11 determine each occupant's identity, by executing a software such as an image recognition software, a voice recognition software, or a weight recognition software, based on the received data from sensor 36 and/or user interface 26. For another example, sensor 36 may detect a digital signature or other identification information from mobile communication devices that occupants may carry, and processing unit 104 may determine the occupants' identifies based on the digital signatures. Processing unit 104 may access and collect sets of data related to each occupant in vehicle 10. Processing unit 104 may determine whether the determined occupants have stored profiles. Processing unit 104 may also access sets of data stored on mobile communication device 80, 82 and third party devices 90 to update the stored profile(s). If an occupant does not have a stored profile, processing unit 104 may generate a profile based on the accessed data. Each profile may include information such as age, gender, driving license status, ADAS license status, driving habit, frequent destination, or enrolled store reward program. For example, processing unit 104 may determine the interests of one or more (e.g., each) of the occupants of vehicle 10 according to their enrolled store reward programs. Processing unit 104 may determine each of the occupant's preferences, for example, in audio, movies, and food.

In some embodiments, one or more components of system 11 may determine other information, such as a Global Positioning System (GPS) signal, sign information, road mark information, weather information, route traffic information, lane traffic information, lane feature information, vehicle feature information, or environment information described in more details below and which can be performed at this step or a later step.

In Step 320, one or more components of system 11 may determine a current position of the vehicle. For example, as illustrated in FIGS. 1 and 2, vehicle 10 may determine a current position of vehicle 10. In some embodiment, detector and GPS 24 may include a GPS unit that communicates with space-level sensors (e.g., satellites), air-level sensors (e.g., balloon-carried sensors), and/or ground-level sensors (e.g., street cameras, transmission towers) to determine a current location of the vehicle. Detector and GPS 24 may store and use a high resolution map that includes lane maps and information.

In some embodiments, detector and GPS 24 may also include one or more detectors (e.g., cameras) that detect street signs, lane patterns, road marks, weather conditions, and/or road conditions to help determine a current lane of vehicle 10 and/or detect information to help determine a recommended lane described below with reference to step 350. The road condition may be lane-specific. For example, detector and GPS 24 may detect that a left lane is covered with snow or a carpool lane is congested. For another example, detector and GPS 24 may determine that vehicle 10 is a wirelessly chargeable electric car, but also detect that an electric re-charging lane, which wirelessly charges cars above through embedded charging devices, is under repair. Similarly, detector and GPS 24 may transmit all processed data and information to processing unit 104 to perform various steps. This is, the detector and GPS unit may receive at least one of a Global Positioning System (GPS) signal, sign information, road mark information, weather information, route traffic information, lane traffic information, lane feature information, vehicle feature information, or environment information. Accordingly, processing unit 104 may perform various steps or methods, such as determining a recommended lane as described below with reference to step 350, based on the information received by the detector and GPS unit. The environment information may include whether the recommended lane is cleared for normal traffic.

In some embodiments, processing unit 104 may obtain traffic information and/or weather information from external devices 80, 90, or 82 through network 70. The traffic information may include traffic information of each lane of a roadway.

In Step 330, one or more components of system 11 may determine a destination of the vehicle. For example, as illustrated in FIGS. 1 and 2, vehicle 10 may determine a destination of vehicle 10. In some embodiments, an occupant of vehicle 10 may input the destination through user interface 26, such as directly entering an address of the destination. In some embodiments, an occupant of vehicle 10 may input the destination through sensor 36, such as sending instructions through the electrophysiological sensors. In some embodiments, vehicle 10 may determine the destination. For example, processing unit 104 may store data such as individual's frequent restaurants in relation to the time of the day and the vehicle location at storage unit 106 and/or memory module 108. After determining the driver's favorite luncheon restaurant ABC, the time of the day to be lunch time, the location of the vehicle to be close to restaurant ABC, and no other passengers on the vehicle, processing unit 104 may determine the destination to be restaurant ABC.

In Step 340, one or more components of system 11 may determine a route from the current position to the destination. For example, as illustrated in FIGS. 1 and 2, vehicle 10 may determine a route for vehicle 10 from the current position to the destination. One or more roads on the route may include one or more lanes. In some embodiments, processing unit 104 may receive map information from mobile communication devices 80,82, third party device 90, and/or detector and GPS 24, and store the map information at storage unit 106 and/or memory module 108. The map information may include location-based weather information and traffic information. Upon determining the current position and the destination of vehicle 10, processing unit 104 may locate the current position and the destination according to the map information, and determine one or more possible routes from the current position to the destination. In some embodiments, the route may comprise one or more lanes, and processing unit 104 may further determine one or more possible lane-specific routes from the current position to the destination. For example, processing unit 104 may determine three lane-specific routes from a current position to restaurant XYZ: (1) staying on the leftmost HOV (2+) (or carpool) lane of route 66 for 10 miles, then taking a left exit ramp to route 1, and staying on the rightmost lane of route 1 for 20 miles to reach restaurant XYZ; (2) staying on the local lane of route 66 for 10 miles, then taking a right exit ramp to route 1, and staying on the rightmost lane of route 1 for 20 miles to reach restaurant XYZ; and (3) staying on the leftmost HOV lane of route 66 for 10 miles, then taking a left exit ramp to route 1, staying on the rightmost lane of route 1 for 10 miles, taking a right exit ramp to country road 88, and staying on country road 88 for 15 miles to reach restaurant XYZ.

In Step 350, one or more components of system 11 may determine a recommended lane of the route based on the determined vehicle occupant information, e.g., the determined number of occupants. Step 350 may be a sub-step of 340 or an independent step. For example, vehicle 10 may determine the recommended lane for vehicle 10 based on at least one of a shortest traveling time or a shortest traveling distance. Continuing with the example of the three determined routes described above with respect to Step 340, in some embodiments, if processing unit 104, in conjunction with sensor 36 and/or user interface 26, determines that the number of occupants of vehicle 10 is 1, processing unit 104 may eliminate routes 1 and 3 due to the HOV lane occupancy restriction and may recommend route 2. In some embodiments, if processing unit 104, in conjunction with sensor 36 and/or user interface 26, determines that the number of occupants of vehicle 10 is 3, processing unit 104 may determine that vehicle 10 can travel on any of the three determined routes, and may further compare total traveling times for routes 1, 2, and 3 to determine the recommended lane, provided that traveling in a shortest time is the only constraint for determining the recommended lane. Thus, processing unit 104 may determine and recommend route 1, if it determines that traveling via route 1 takes less time than route 2 and route 3. Continuing with the examples described above with respect to Step 320, in some embodiments, processing 104 unit may eliminate a lane from recommendation based on received signals, for example, when the received signals indicate that the lane is not cleared for normal traffic (e.g., covered with snow), has too much traffic, or is not functioning (e.g., not performing wireless charging).

In some embodiments, the processing unit 104 may determine the recommended lane based on the determined profiles described above with respect to step 310. For example, when processing unit 104 determines that an occupant of vehicle 10 has a valid ADAS license, processing unit 104 may include an ADAS lane into options for determining the recommended lane.

In some embodiments, processing unit 104 may, in conjunction with sensor 36, determine a feature of the vehicle, for example, whether vehicle 10 is an autonomous vehicle, whether vehicle 10 is a wireless charging vehicle chargeable on a wireless charging lane, and/or whether vehicle 10 has an electronic payment device (e.g., E-ZPass™). The processing unit 104 may determine the recommended lane based on the determined vehicle feature. For example, if processing unit 104 determines that vehicle 10 is equipped with an electronic payment device E-ZPass, a possible route passes through a toll booth having E-ZPass lanes and cash lanes, and the E-ZPass lanes are less congested than other lanes, processing unit 104 may determine the recommended lane to include the E-ZPass lanes. Processing unit 104 may further determine a least-congested E-ZPass lane of all E-ZPass lanes as a part of the recommended lane, based on, for example, traffic information captured by toll booth cameras and transmitted to onboard computer 100 via network 70.

In some embodiments, processing unit 104 may determine the recommended lane based on environment information, such as the weather condition or the road condition described above with respect to step 310. Continuing with the example of three determined-routes described above with respect to Step 340, if processing unit 104 determines that the HOV lane is covered with snow, it may eliminate route 1 and route 3 from the recommendation.

In some embodiments, processing unit 104 may display or broadcast the determined recommended lane(s) through user interface 26 and/or mobile communication devices 80, 82 to the occupant(s) of vehicle 10.

In some embodiments, processing unit 104 may control vehicle 10 to travel according to the determined recommended lane.

In some embodiments, processing unit 104 may determine the recommended lane based on various times of the day. For example, processing unit 104 may determine a few options of recommended lanes, associated routes, and travel time based on traveling at different times of a day, and output such information to user interface 26, mobile communication devices 80, 82, and/or third party device 90. Thus, the drive or another person may determine the best time to travel according the output information.

In some embodiments, the above-described systems and methods can be applied to competition vehicles, such as race cars and motorcycles. For example, the systems and methods can be implemented to assist with racing by identifying a fastest traveling lane or a combination of traveling lanes and maneuvers for the vehicle. Output generated by systems can be transmitted to third party device 90, e.g., a computer, for further analysis by a race crew.

In some embodiments, the above-described systems and methods can be applied to vehicles in a platoon, or can determine the recommended lane based on platoon information on various lanes and/or routes. Vehicles traveling in a platoon may travel in a formation with small separations, and accelerate and brake together. Autonomous vehicles may join or leave the platoon formation automatically. Vehicle 10 may determine the recommended lane based on a license status of the driver, a status of vehicle 10, and/or a presence of traveling platoons. For example, vehicle 10 may determine that traveling on lane X on a certain highway is preferable over other lanes, because a platoon is coming by, and vehicle 10 can automatically join the traveling platoon, which almost always travel at a higher speed than other vehicles on the highway.

Another aspect of the disclosure is directed to a non-transitory computer-readable storage medium storing instructions which, when executed, cause one or more processors to perform the method, as discussed above. The computer-readable storage medium may include volatile or non-volatile, magnetic, semiconductor, tape, optical, removable, non-removable, or other types of computer-readable storage medium or computer-readable storage devices. For example, the computer-readable storage medium may be the storage unit or the memory module having the computer instructions stored thereon, as disclosed. In some embodiments, the computer-readable storage medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for lane-based vehicle navigation. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A system for lane-based vehicle navigation, the system comprising:
one or more sensors configured to detect a number of occupants in a vehicle; and
a processing unit coupled to the one or more sensors to receive signals from the one or more sensors, and configured to:
determine a current position of the vehicle;
determine a destination of the vehicle;
determine a route from the current position to the destination; and
determine a recommended lane of the route based on the detected number of occupants.

2. The system of claim 1, wherein the one or more sensors include a user interface for receiving a user's input.

3. The system of claim 1, wherein the processing unit is configured to determine the recommended lane based on at least one of a shortest traveling time or a shortest traveling distance.

4. The system of claim 1, wherein:
the one or more sensors are configured to detect one or more identities of the occupants; and
the processing unit is further configured to:
determine one or more profiles based on the detected identities, the profiles including at least one of age, gender, driving license status, advanced driver assistance systems (ADAS) license status, driving habits, frequent destinations, or enrolled store reward programs; and
determine the recommended lane further based on the determined profiles.

5. The system of claim 4, wherein the processing unit is configured to determine the destination based on the determined profiles.

6. The system of claim 1, further comprising a detector unit configured to receive at least one of a Global Positioning System (GPS) signal, sign information, road mark information, weather information, route traffic information, lane traffic information, lane feature information, vehicle feature information, or environment information, wherein the processing unit is configured to determine the recommended lane based on the information received by the detector unit.

7. The system of claim 6, wherein the environment information includes whether the recommended lane is cleared for normal traffic.

8. The system of claim 1, wherein the current position of the vehicle includes a current lane of the vehicle on a roadway.

9. The system of claim 1, wherein the processing unit is configured to determine the destination of the vehicle from an occupant input.

10. A vehicle comprising a system for lane-based vehicle navigation, the system comprising:
one or more sensors configured to detect a number of occupants in a vehicle; and
a processing unit coupled to the one or more sensors to receive signals from the one or more sensors, and configured to:
determine a current position of the vehicle;
determine a destination of the vehicle;
determine a route from the current position to the destination; and
determine a recommended lane of the route based on the detected number of occupants.

11. The vehicle of claim 10, wherein the one or more sensors include a user interface for receiving a user's input.

12. The vehicle of claim 10, wherein the processing unit is configured to determine the recommended lane based on at least one of a shortest traveling time or a shortest traveling distance.

13. The vehicle of claim 10, wherein:
the one or more sensors are configured to detect one or more identities of the occupants; and
the processing unit is further configured to:
determine one or more profiles based on the detected identities, the profiles including at least one of age, gender, driving license status, advanced driver assistance systems (ADAS) license status, driving habits, frequent destinations, or enrolled store reward programs; and
determine the recommended lane based on the determined profiles.

14. The vehicle of claim 13, wherein the processing unit is configured to determine the destination based on the determined profiles.

15. The vehicle of claim 10, further comprising a detector unit configured to receive at least one of a Global Positioning System (GPS) signal, sign information, road mark information, weather information, route traffic information, lane traffic information, lane feature information, vehicle feature information, or environment information, wherein the processing unit is configured to determine the recommended lane based on the information received by the detector unit.

16. The vehicle of claim 15, wherein the environment information includes whether the recommended lane is cleared for normal traffic.

17. The vehicle of claim 10, wherein the current position of the vehicle includes a current lane of the vehicle on a roadway.

18. The vehicle of claim 10, wherein the processing unit is configured to determine the destination of the vehicle from an occupant input.

19. A method for lane-based vehicle navigation, the method comprising:
detecting a number of occupants in a vehicle;
determining a current position of the vehicle;
determining a destination of the vehicle;
determining a route from the current position to the destination; and
determining a recommended lane of the route based on the detected number of occupants.

20. The method of claim 19, wherein determining the recommended lane comprises determining the recommended lane further based on at least one of a Global Positioning System (GPS) signal, sign information, road mark information, weather information, route traffic information, lane traffic information, lane feature information, vehicle feature information, or environment information.
